(19) United States
(12) Patent Application Publication
(10) Pub. No.: US 2009/0164880 A1
(43) Pub. Date: Jun. 25, 2009

(54) Methods And Systems For Generating A Media Stream Expression For Association With A Cell Of An Electronic Spreadsheet

(76) Inventor: David B. Lection, Raleigh, NC (US)

Correspondence Address: SCENERA RESEARCH, LLC, 111 CORNING RD., SUITE 220, CARY, NC, 27518, US

(21) Appl. No.: 11/960,079

(22) Filed: Dec. 19, 2007

(51) Int. Cl. G06F 17/00; G06F 3/00

(52) U.S. Cl. 715/212; 715/716

(57) ABSTRACT

Methods and systems are described for generating a media stream expression for association with a cell of an electronic spreadsheet. In one embodiment, a method includes receiving a selection including at least one cell included in the electronic spreadsheet. The selection includes a plurality of media streams associated with the at least one cell. The method also includes presenting a graphical user interface including graphical objects presented in a first arrangement representing the plurality of media streams. The method further includes receiving input for manipulating at least one of the graphical objects for presenting the graphical objects in a second arrangement. The method also includes generating a media stream expression based on the second arrangement of graphical objects. The method further includes associating the media stream expression with a cell. The media stream expression for evaluation by the electronic spreadsheet to generate a resultant media stream.

### BACKGROUND

In today's spreadsheet applications, spreadsheets are presented as a two-dimensional presentation space. Each addressable location in the spreadsheet is called a cell, and each cell can hold data. The value of a cell can be calculated depending on other cells. As those cells change value, dependent cell values are also recalculated.

Today's spreadsheets are typically limited to text data, for example numbers, and in limited situations image data. In some cases, a spreadsheet will allow a graphic in a cell as a static item of content that aids in the formatting of the spreadsheet. Today's spreadsheets can also render graphs from included data. Today's spreadsheets offer dialog controls for editing text data and graphs. Today's spreadsheets do not allow for generating a media stream using a dialog presented by the spreadsheet.

Accordingly, there exists a need for methods, systems, and computer program products for generating a media stream expression for association with a cell of an electronic spreadsheet.

### SUMMARY

Methods and systems are described for generating a media stream expression for association with a cell of an electronic spreadsheet. In one embodiment, a method includes receiving a selection including at least one cell included in an electronic spreadsheet having a plurality of cells. The selection includes a plurality of media streams associated with the at least one cell. The method also includes presenting a graphical user interface including graphical objects presented in a first arrangement representing the plurality of media streams. The method further includes receiving input via the graphical user interface for manipulating at least one of the graphical objects for presenting the graphical objects in a second arrangement. The method still further includes generating a media stream expression based on the second arrangement of graphical objects. The method also includes associating the media stream expression with a cell of the electronic spreadsheet, the media stream expression for evaluation by the electronic spreadsheet to generate a resultant media stream from the media streams represented.

According to an aspect, a system for generating a media stream expression for association with a cell of an electronic spreadsheet is disclosed. The system includes means for receiving a selection including at least one cell included in an electronic spreadsheet having a plurality of cells, wherein the selection includes a plurality of media streams associated with the at least one cell. The system also includes means for presenting a graphical user interface including graphical objects presented in a first arrangement representing the plurality of media streams. The system further includes means for receiving input via the graphical user interface for manipulating at least one of the graphical objects for presenting the graphical objects in a second arrangement. The system still further includes means for generating a media stream expression based on the second arrangement of graphical objects. The system also includes means for associating the media stream expression with a cell of the electronic spreadsheet, the media stream expression for evaluation by the electronic spreadsheet to generate a resultant media stream from the media streams represented by the second arrangement of graphical objects.

According to an aspect, a system for generating a media stream expression for association with a cell of an electronic spreadsheet is disclosed. The system includes a cell selection manager component configured for receiving a selection including at least one cell included in an electronic spreadsheet having a plurality of cells. The selection includes a plurality of media streams associated with the at least one cell. The system also includes a dialog renderer component configured for presenting a graphical user interface including graphical objects presented in a first arrangement representing the plurality of media streams. The system also includes a dialog input manager component configured for receiving input via the graphical user interface for manipulating at least one of the graphical objects for presenting the graphical objects in a second arrangement. The system further includes a formula builder component configured for generating a media stream expression based on the second arrangement of graphical objects. The system still further includes a cell list manager component configured for associating the media stream expression with a cell of the electronic spreadsheet, the media stream expression for evaluation by the electronic spreadsheet to generate a resultant media stream from the media streams represented by the second arrangement of graphical objects.

According to another aspect, a computer readable medium including a computer program, executable by a machine, for generating a media stream expression for association with a cell of an electronic spreadsheet is disclosed. The computer program includes executable instructions for receiving a selection including at least one cell included in an electronic spreadsheet having a plurality of cells. The selection includes a plurality of media streams associated with the at least one cell. The computer program includes executable instructions for presenting a graphical user interface including graphical objects presented in a first arrangement representing the plurality of media streams. The computer program includes executable instructions for receiving input via the graphical user interface for manipulating at least one of the graphical objects for presenting the graphical objects in a second arrangement. The computer program includes executable instructions for generating a media stream expression based on the second arrangement of graphical objects. The computer program includes executable instructions for associating the media stream expression with a cell of the electronic spreadsheet, the media stream expression for evaluation by the electronic spreadsheet to generate a resultant media stream from the media streams represented by the second arrangement of graphical objects.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for generating a media stream expression for association with a cell of an electronic spreadsheet according to an embodiment of the subject matter described herein;

FIG. 2 is a block diagram illustrating a system for generating a media stream expression for association with a cell of an electronic spreadsheet according to another embodiment of the subject matter described herein;

FIG. 3 is a block diagram illustrating a system for generating a media stream expression for association with a cell of an electronic spreadsheet according to another embodiment of the subject matter described herein;

FIG. 4 is a block diagram illustrating an exemplary user interface for use in a system for generating a media stream expression for association with a cell of an electronic spreadsheet according to another embodiment of the subject matter described herein;

FIG. 5A is a block diagram illustrating an exemplary user interface for use in a system for generating a media stream expression for association with a cell of an electronic spreadsheet according to another embodiment of the subject matter described herein;

FIG. 5B is a block diagram illustrating an exemplary user interface for use in a system for generating a media stream expression for association with a cell of an electronic spreadsheet according to another embodiment of the subject matter described herein;

FIG. 6 is a block diagram illustrating an exemplary user interface for use in a system for generating a media stream expression for association with a cell of an electronic spreadsheet according to another embodiment of the subject matter described herein;

FIG. 7 is a block diagram illustrating an exemplary user interface for use in a system for generating a media stream expression for association with a cell of an electronic spreadsheet according to another embodiment of the subject matter described herein;

FIG. 8A is a block diagram illustrating an exemplary user interface for use in a system for generating a media stream expression for association with a cell of an electronic spreadsheet according to another embodiment of the subject matter described herein;

FIG. 8B is a block diagram illustrating an exemplary user interface for use in a system for generating a media stream expression for association with a cell of an electronic spreadsheet according to another embodiment of the subject matter described herein; and

FIG. 9 is a block diagram illustrating an exemplary user interface for use in a system for generating a media stream expression for association with a cell of an electronic spreadsheet according to another embodiment of the subject matter described herein.

### DETAILED DESCRIPTION

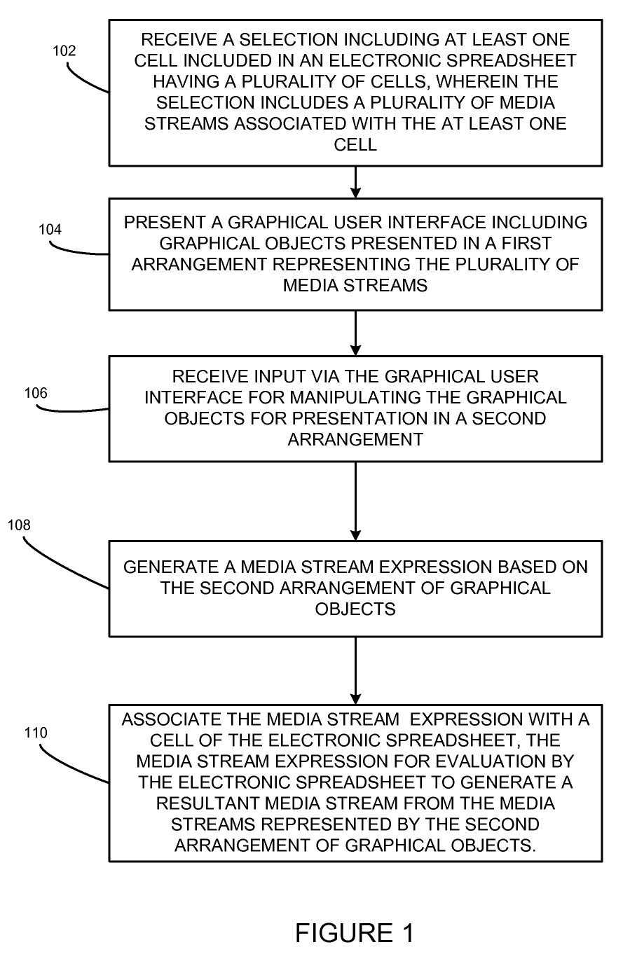

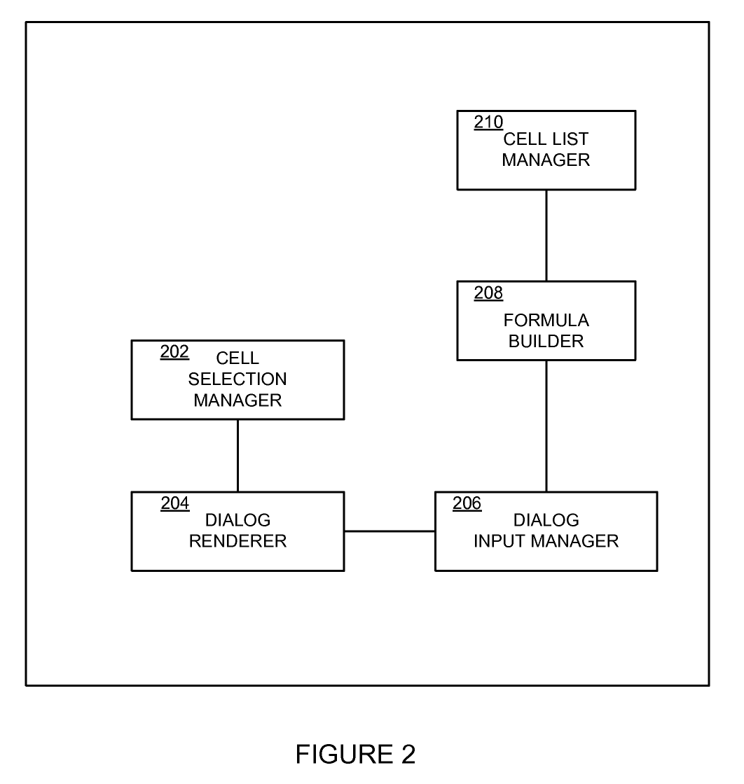

FIG. 1 is a flow diagram illustrating a method for generating a media stream expression for association with a cell of an electronic spreadsheet according to an exemplary embodiment of the subject matter described herein. FIG. 2 is a block diagram illustrating a system for generating a media stream expression for association with a cell of an electronic spreadsheet according to another exemplary embodiment of the subject matter described herein. The method illustrated in FIG. 1 can be carried out by, for example, some or all of the components illustrated in FIG. 2.

With reference to FIG. 1, in block 102 a selection including at least one cell included in an electronic spreadsheet having a plurality of cells is received. The selection includes a plurality of media streams associated with the selected at least one cell. Accordingly, a system for generating a media stream expression for association with a cell of an electronic spreadsheet includes means for receiving a selection including at least one cell included in an electronic spreadsheet having a plurality of cells. For example, as illustrated in FIG. 2, a cell selection manager component 202 is configured for receiving a selection including at least one cell included in an electronic spreadsheet having a plurality of cells. The selection includes a plurality of media streams associated with the at least one cell.

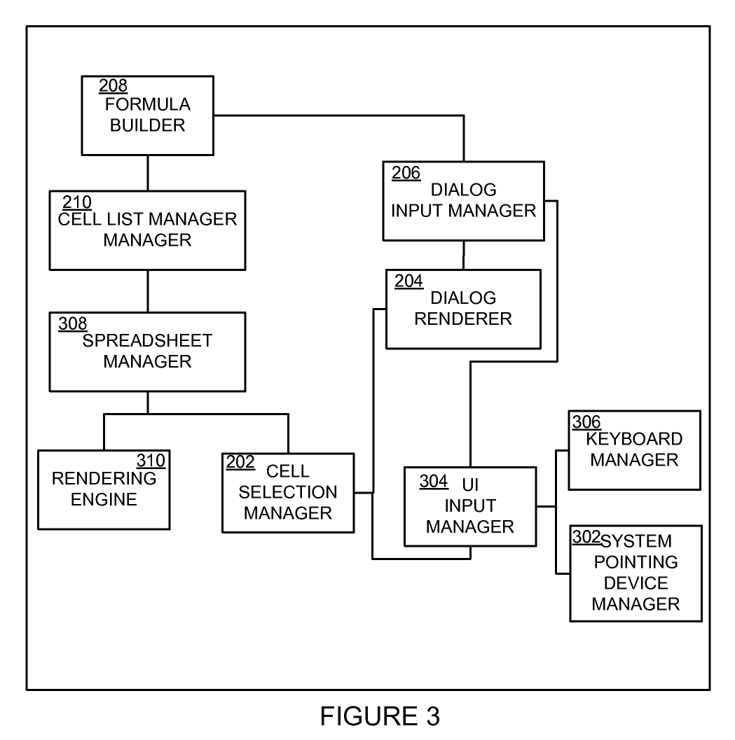

The cell selection manager component 202 of FIG. 2 can be configured to manage a selection of spreadsheet cells. For example, as illustrated in FIG. 3, the cell selection manager component 202 can communicate with a system pointing device manager component 302 accepting system pointing device input events. The selection can be of one cell including a plurality of media cells, multiple cells each containing an individual media stream, or any combination thereof. For example, a user interface (UI) input manager component 304 can be configured to transmit input from the system pointing device manager component 302 to the cell selection manager component 202. Alternatively or in addition, a keyboard manager component 306 can be configured to provide input events to the UI input manager component 304.

The UI input manager component 304 can be configured to calculate the location and the region size of the spreadsheet selection from the input actions and pass this region and location to the cell selection manager component 202. The cell selection manager component 202 can then determine the cell or cells included in the selection and marks the cells selected by calling a spreadsheet manager component 308 with a list of selected cell ID's. The spreadsheet manager component 308 can then call a spreadsheet rendering engine component 310 to update the spreadsheet display to illustrate the cells selected.

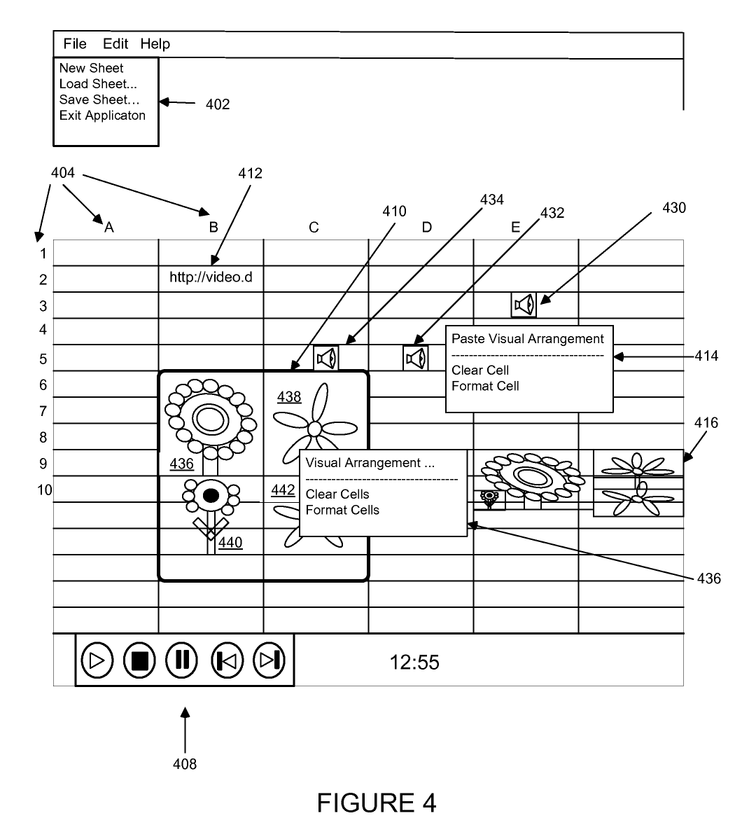

For example, the UI input manager component 304 can receive input that defines a cell selection rectangle. A cell selection rectangle is a selection area, rectangular in shape, which contains a selection of at least one cell of a spreadsheet. The cell selection manager component 202 determines if any of the spreadsheet cells in the selection contain a media stream. Irrespective of the source of the selection, a received selection can define a selection rectangle including at least one cell. For example, FIG. 4 illustrates an exemplary spreadsheet including a plurality of cells. FIG. 4 includes a file menu 402, cell row and column identifiers 404 and spreadsheet play controls 408. Included in the plurality of cells are cell 412, cell 430, cell 432 and cell 434. An exemplary selection rectangle 410 is illustrated including a plurality of cells including cell 436, cell 438, cell 440 and cell 442.

Returning to FIG. 1, in block 104 a graphical user interface (GUI) is presented. The GUI includes graphical objects presented in a first arrangement representing the plurality of media streams. Accordingly, a system for generating a media stream expression for association with a cell of an electronic spreadsheet includes means for presenting a graphical user interface including graphical objects presented in a first arrangement representing the plurality of media streams. For example, as illustrated in FIG. 2, a dialog renderer component 204 is configured for presenting a graphical user interface including graphical objects presented in a first arrangement representing the plurality of media streams.

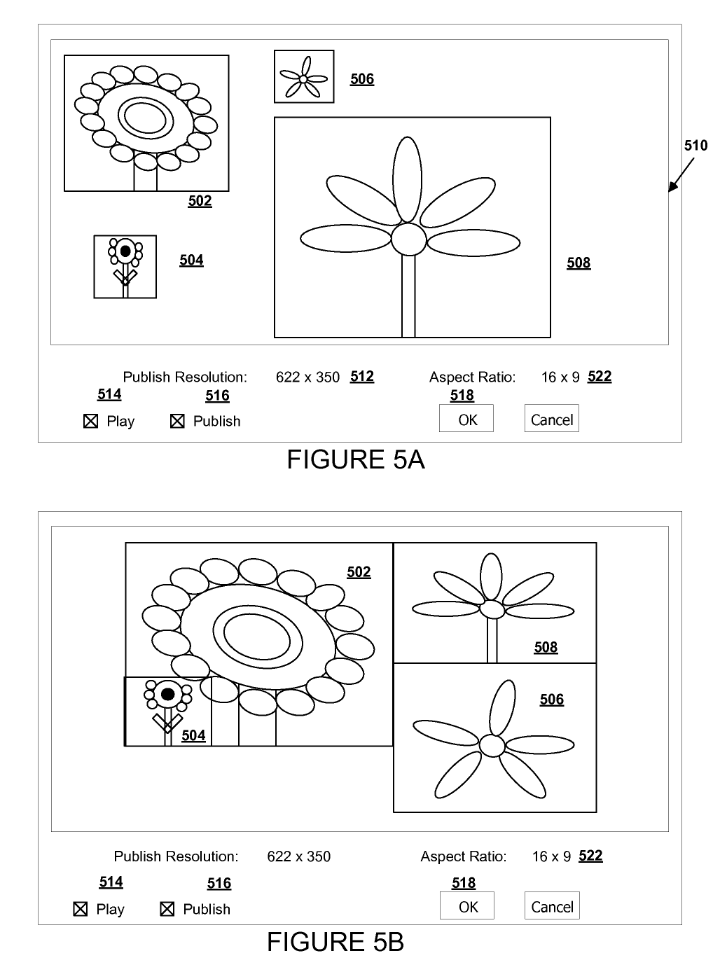

For example, the dialog renderer component 204 displays a GUI that allows the user to visually arrange the media stream components in a spreadsheet selection area. FIGS. 5A, 5B, 6, 7, 8A, and 8B are all examples of visual arrangement dialog GUI's. An example of the invocation of the visual arrangement dialog renderer begins with a selection. As discussed above, so selection rectangle 410 of FIG. 4 illustrates a cell selection rectangle that has selected four cells with media streams. These streams contain video media. When the visual arrangement command is applied to these streams they are presented in a dialog that enables further sizing and arrangement of each media stream. FIG. 5A illustrates an example dialog renderer component 204 with the video based media streams available for sizing and movement. Graphical objects 502, 504, 506 and 508 represent each of the cells included in the selection. For example graphical object 502 is a representation of the media stream included in the cell 436 included in the selection rectangle 410 of FIG. 4. Similarly graphical objects 504, 506 and 508 represent cells 438, 440 and 442 respectively.

The dialog renderer component 204 can display the visual arrangement dialog GUI when the “Visual Arrangement . . . ” command is selected from the context menu as illustrated in component 436 of FIG. 4. When the command is selected by mouse or keyboard action the UI input manager component 304 receives the command input. The UI input manager component 304 can call the dialog renderer component 204 to display the visual arrangement dialog GUI on the display.

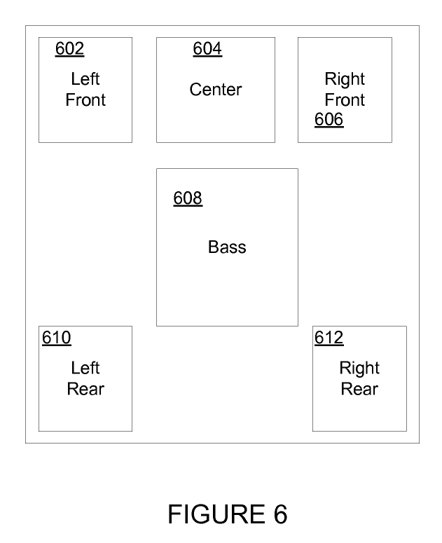

FIG. 6 illustrates an example of a visual arrangement dialog that includes audio based media streams. FIG. 6 illustrates an example including multi-channel audio stream. Specifically, FIG. 6 illustrates an embodiment of the dialog with a 5.1 audio stream. Specifically object 602 represents a media stream corresponding to the media stream sent to the left front speaker. Likewise, objects 604-612 represent media streams that are sent to the center, right front, bass, left rear, and right rear speakers respectively.

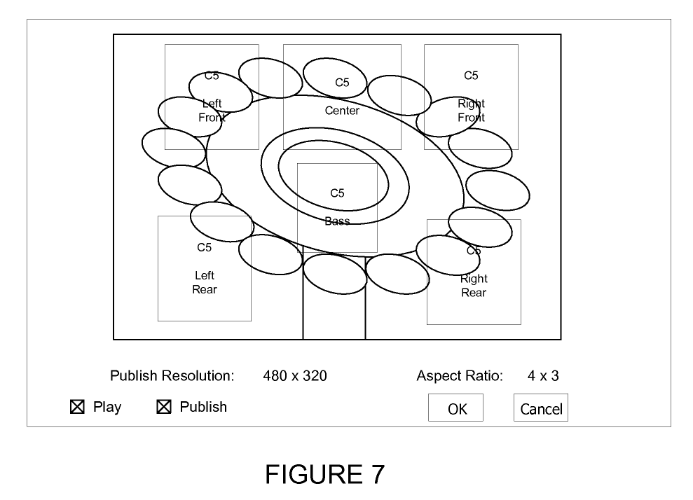

FIG. 7 illustrates an embodiment with a media stream that contains both a video stream and a multi-channel 5.1 audio stream. In this embodiment the component icons representing the component sub-channels of the audio stream are overlaid on the presentation of the video in the visual arrangement dialog.

As one skilled in the art will recognize that any combination of audio, video, or audio/video media streams can be presented in a visual arrangement dialog with the streams illustrated as icons as illustrated in the above examples. These examples are illustrative, and not intended to limit the potential functionality in any way.

Returning to FIG. 1, in block 106 input is received via the graphical user interface for manipulating at least one of the graphical objects for presenting the graphical objects in a second arrangement. Accordingly, a system for generating a media stream expression for association with a cell of an electronic spreadsheet includes means for receiving input via the graphical user interface for manipulating at least one of the graphical objects for presenting the graphical objects in a second arrangement. For example, as illustrated in FIG. 2, a dialog input manager component 206 is configured for receiving input via the graphical user interface for manipulating at least one of the graphical objects for presenting the graphical objects in a second arrangement.

For example, with reference also to FIG. 3, the system pointing device manager component 302 can send system pointing device events to the UI input manager component 304 for processing. Alternatively, the keyboard manager component 306 can send spreadsheet command and actions to the UI input manager component 304 for processing. If a visual arrangement dialog is active and displayed these events are forwarded to the visual arrangement dialog input manager component 206 for processing. The dialog renderer component 204 and the dialog input manager component 206 can together provide the representations of the each media stream and enable dragging, and sizing, and other media operations for all media streams and components represented as icons in the visual arrangement dialog. The dialog renderer can also display a scaled rectangle component 510 within the visual arrangement sizing dialog which conforms to the aspect ratio of the desired result. The default aspect ratio can be set in the user preferences section of the media spreadsheet (not illustrated). The user can also drag and size the scaling rectangle to affect the dimensions and aspect ratio of the represented streams illustrated in the visual arrangement dialog.

According to an aspect, media stream information can be presented in the graphical user interface in response to receiving input for manipulating the graphical objects. The media stream information can represent presentation properties of the media streams represented by the graphical objects. The dialog renderer component 204 can be configured for presenting media stream information in the graphical user interface in response to receiving input for manipulating the graphical objects, wherein the media stream information represents presentation properties of the media streams represented by the graphical objects. For example, media stream information including a size value 512 and an aspect ratio value 522 can be illustrated in the visual arrangement dialog. The dialog input manager component 206 can determine the composite size and aspect ratio of the stream produced by the function generated when the visual arrangement dialog arrangement has been completed. The user can indicate the user is finished arranging the media objects by invoking an “OK” button 508.

Media streams and stream components can then be sized and positioned within the visual arrangement dialog. FIG. 5A illustrates a selection of media video media streams. As illustrated in FIG. 5A these streams were provided from the cell selection rectangle component 410 of FIG. 4. FIG. 5B is the result of the user moving, sizing and rearranging the media streams. Stream 502 was resized larger. Stream 504 was moved over top of the stream 502. Stream 506 was sized larger and moved to the right so as to border but not overlap stream 502. Stream 508 was sized and moved to border streams 502 and 506.

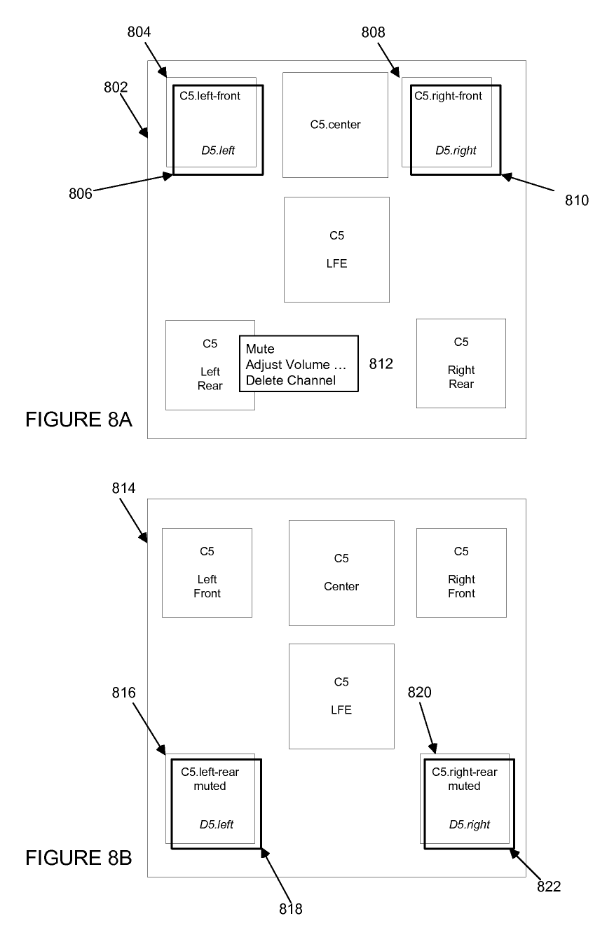

When a multi-channel audio stream is displayed and manipulated in the visual arrangement dialog component, as illustrated in FIGS. 8A and 8B, the position of the icons determine the sound field of rendering when a user hears the stream being rendered with an appropriate set rendering hardware. For example to accurately experience a stereo audio stream as least two speakers are required, one for the left channel and one for the right channel. In order to accurately experience a 5.1 channel audio stream, 6 speakers are required. In a typical arrangement, three speakers are placed in front of the user. These speakers render the front-left channel, the center channel, and the front-right channels. Behind the user rear-left and rear-right speakers are placed. A subwoofer bass speaker for the low frequency effect (LFE) channel can be placed anywhere in the room, since the characteristics of low frequency bass sounds are omni-directional.

The dialog renderer component 204, positions displays the “front” of the audio rendering space at the top of the display, and the “rear” of the audio rendering space at the bottom. As audio icons are moved within the dialog, their rendering characteristics are adjusted to represent their current position. These rendering characteristics include both the adjustment of the relative volume of the channel and delay of the audio between the front and rear channels to simulate an echo induced spatial sound field. As channels are moved closer together any delay between the channels is minimized, reducing any perceivable echo.

FIG. 8A illustrates a dialog 802 in which two multi-channel audio streams are being combined. The first multi-channel stream is a stereo stream with a left and right channel. This stream is mapped by the stereo stream icons labeled “D5.left” and “D5.right”. The “D5” label represents the source spreadsheet cell illustrated at components 804-810. The second audio stream is a 5.1 channel audio stream represented by the six boxes labeled “C5”. In this example the user wanted to mix the two streams creating a new multi-channel 5.1 stream, where the first stream (stereo stream) replaces the rear left and rear right streams of the second media stream. Context menu 812 can be included for providing available operations that can be applied to an audio channel. The “Mute” function is selected. The system can apply a mute function to the channel, silencing the channel. Dialog 814 of FIG. 8B illustrates an example of the placement of objects 816-822 as a result of these operations. The user moved the D5.left and D5.right stereo stream icons to the bottom of the arrangement area. The user can then display the context menu of available stream operations, by for example, clicking each of the icons that represent the rear audio channels of stream “C5” using a system pointing device.

Returning to FIG. 1, in block 108 a media stream expression is generated based on the second arrangement of graphical objects. Accordingly, a system for generating a media stream expression for association with a cell of an electronic spreadsheet includes means for generating a media stream expression based on the second arrangement of graphical objects. For example, as illustrated in FIG. 2, a formula builder component 208 is configured for generating a media stream expression based on the second arrangement of graphical objects.

For example, the formula builder component 208 creates a media stream expression based on a second arrangement of the graphical objects representing the stream components. For example, the arrangement can include the relative positions and other settings entered in and contained in an instance of the graphical objects presented in the visual arrangement dialog. As illustrated in FIG. 5B, when the “OK” button 518 of the visual arrangement dialog is invoked, the formula builder component 208 receives the current position, size, volume (audio), mute (audio), for each media stream represented in the visual arrangement dialog. The visual arrangement dialog can then be terminated and the display of the GUI can be erased from the screen.

The formula builder component 208 can create a media stream expression that represents the components of the stream in their spatial positions with components placed visually, and for audio streams placed within the sound field, based on their representative icon positions in the visual arrangement dialog. Various forms input manipulating the objects can result in various media stream expressions.

In another aspect, the received input for manipulating at least one of the graphical objects includes input for sizing a graphical object. The resultant media stream expression, when evaluated by the electronic spreadsheet, generates a resultant media stream including the stream represented by the graphical object presented according to presentation parameters defined by the sizing of the graphical object. For example, the dialog input manager 206 component can be configured for receiving input for manipulating at least one of the graphical objects includes receiving input for sizing a graphical object. The formula builder component 208 can be configured for generating the media stream expression for, when evaluated by the electronic spreadsheet, generating a resultant media stream including the stream represented by the graphical object presented according to presentation parameters defined by the sizing of the graphical object.

In another aspect, input for arranging the graphical objects in a sequence is received. The resultant media stream expression, when evaluated by the electronic spreadsheet, generates a resultant media stream including the streams represented by the graphical objects presented in the sequence. For example, the dialog input manager 206 component can be configured for receiving input for arranging the graphical objects in a sequence. The formula builder component 208 can be configured for generating the media stream expression for, when evaluated by the electronic spreadsheet, generating a resultant media stream including the streams represented by the graphical objects presented in the sequence.

In another aspect, input for overlaying a first graphical object over a second graphical object can be received. The resultant media stream expression, when evaluated by the electronic spreadsheet, generates a resultant media stream including the stream represented by the first graphical object presented overlaying the stream represented by the second graphical object. For example, the dialog input manager 206 component can be configured for receiving input for overlaying a first graphical object over a second graphical object. The formula builder component 208 can be configured for generating the media stream expression for, when evaluated by the electronic spreadsheet, generating a resultant media stream including the stream represented by the first graphical object presented overlaying the stream represented by the second graphical object.

In another aspect, input moving a graphical object along a path in the graphical user interface is received. The resultant the media stream expression, when evaluated by the electronic spreadsheet, generates a resultant media stream including the stream represented by the graphical object presented along the path. For example, the dialog input manager 206 component can be configured for receiving input for moving a graphical object along a path in the graphical user interface. The formula builder component 208 can be configured for generating the media stream expression for, when evaluated by the electronic spreadsheet, generating a resultant media stream including the stream represented by the graphical object presented along the path.

In another aspect, input for positioning a graphical object in a location associated with a representation of a media output device included in the graphical user interface is received. The resultant the media stream expression, when evaluated by the electronic spreadsheet, generates a resultant media stream including the media stream represented by the graphical object configured for presentation by the media output device associated with the media output device representation. For example, the dialog input manager component 206 can be configured for receiving input for positioning a graphical object in a location associated with a representation of a media output device included in the graphical user interface. The formula builder component 208 can be configured for generating a media stream expression that, when evaluated by the electronic spreadsheet, generates a resultant media stream including the media stream represented by the graphical object configured for presentation by the media output device associated with the media output device representation.

Referring to FIGS. 5A and 5B, the manipulation of a plurality of video streams is illustrated. The plurality of media streams are selected via the selection rectangle 410 of FIG. 4. As described above, each of the individual streams in FIG. 5A is sourced from its respective cell. For example, the object 502 is sourced from cell “B6” 436, the object 504 is sourced from cell “B10” 440, the object 506 is sourced from cell “C6” 438, and the object 508 is sourced from cell “C10” 442.

FIG. 5A illustrates the initial placement of the objects representing the streams within the visual arrangement dialog. Within the visual arrangement dialog, the objects representing the streams are illustrated scaled in relationship to the publish size of the visual arrangement dialog. The visual arrangement rectangle 510 can conform to the dimensions illustrated in publish resolution value 512 and the aspect ratio value 522. The publish size can be used as the composite size for the combined streams. The publish size can be initially set in a user preferences dialog (not illustrated).

FIG. 5B illustrates the final placement of the objects representing the video media streams after receiving input for manipulating the object. The object 504 has been moved within the bounds of the object 502 which has been resized. The object 506 has been moved to the bottom right of the display, and the object 508 has been moved to the top right of the display. The object 506 has also been resized larger.

In response to these manipulations, the following media stream expression is generated

| | | |
|---|---|---|
| =CreateVideoStream( | 622, 350 | // Size of final stream |

| | |
|---|---|
| CreatePIPVideo( SizeVideo(B6, 300, 180), | // Stream 1 |
| SizeVideo(B10, 60, 60), | // Stream 2 |
| lower-left), | // PIP Location |

| 50, 10, | // Location of PIP Stream X, Y |
|---|---|
| SizeVideo( C6, 120, 120 ) | |
| 351, 10, | // Location of Stream X, Y |
| SizeVideo( C10, 120, 90 ) | |
| 351, 131 | // Location of Stream X, Y |

)

The “CreateVideoStream” media stream expression illustrated above can be used as a function to assemble the component video streams into a single composite video stream. The function takes a number of parameters: The first set of numbers is the composite X and Y size of each frame of the stream in pixels. These numbers can be set originally in a user preferences dialog (not illustrated) and can be displayed in the visual arrangement dialog renderer during moving and sizing operations. The next parameter identifies the first stream to be combined. The source of this stream can be another media stream expression. In the expression above, the function “CreatePIPVideo” function takes two component streams and produces a composite picture in a picture stream. For example, the function can combine streams from cells “B6” and “B10” into a picture in a picture stream. The location of the first stream is defined by the pair of values illustrated. The second and third streams are defined source and size values and location values.

Further, the spatial alteration of a stereo audio media stream can be accomplished. The source media stream of a cell can include the left and right components of a stereo stream. Two objects, icons for example, represent each channel. When the two objects are moved toward the center of the visual arrangement dialog, the two channels can be mixed together, diluting the stereo separation. For example, if there is a visual 20% overlap of the icons, 20% of the amplitude of the left channel can be mixed into the right channel. Also 20% of the right channel can be mixed into the left channel. In response, the media stream expression “=CreateStereoAudioStream(E3.left+volume(E3.right,20), E3.right+volume(E3.left, 20))” can be generated by the formula builder component 208. When this formula is inserted into a cell and subsequently played by the spreadsheet, the resulting stereo channels will be mixed as described above.

FIGS. 8A and 8B illustrate the combining of two multi-channel audio media streams. Stream one is a stereo audio media stream from cell “D5” component 432 of FIG. 4. Stream two is a 5.1 channel audio media stream from cell “C5” component 434 of FIG. 4. FIG. 8A illustrates the initial arrangements of the objects that represent the channels of each media stream. In particular, objects 804 and 808 represent the left-front and right-front channels of the second 5.1 audio media stream, and objects 806 and 810 represent the left and right stereo channels of first stereo audio media stream.

For example, the desired result of arranging these streams can be to replace the rear-left channel of the second 5.1 audio media stream with the left channel of the first stereo audio media stream. Likewise, replace the rear-right channel of the second 5.1 audio media stream with the right channel of the first stereo audio media stream. In FIG. 8B input manipulating the objects has been received causing the rear channel components of the second 5.1 channel audio media stream are muted, as illustrated in components 816 and 820. The icons of the first stereo media stream are then repositioned at the bottom of the visual arrangement dialog renderer component 814.

The following media stream expression illustrated is generated as the result of the stream placement and muting illustrated in FIG. 8B.

| | |
|---|---|
| =Create5×1AudioStream( | C5.left-front, |
| | C5.center, |
| | C5.right-front, |
| | D5.left, |
| | D5.right, |
| | C5.lfe ) |

Analyzing the media expression described above, one skilled in the art will recognize that the function creates a new 5.1 audio media stream and uses the corresponding front, center, and low frequency effect (LFE) channels from the original second 5.1 audio media stream, while the rear channels have been replaced with corresponding left and right channels from first stereo media stream.

The generated stream can be visibly rendered or published to the Internet. To facilitate these functions the visual arrangement dialog includes checkbox controls, 522 and 524 of FIG. 5B, for the play “=play” and publish “=publish” functions. When a media stream function is included as a parameter to the play function the stream is rendered visually within the cell that contains the stream. The publish function renders the stream as a remote stream available at the specified URL. Setting the checkbox component 522 causes the composite stream function to be wrapped with a play function. Using the above example, the following play function can be generated:

```
=Play( Create5x1AudioStream( C5.left-front,
        C5.center,
        C5.right-front,
        D5.left,
        D5.right,
        C5.lfe ))
```

Setting the checkbox component 524 causes the composite stream function to be wrapped with the publish function. Using the above example, the following play function can be generated:

```
=Publish( Create5x1AudioStream( C5.left-front,
          C5.center,
            C5.right-front,
            D5.left,
            D5.right,
            C5.lfe ), “http://scenera.live/flowers” )
```

Returning to FIG. 1, in block 110 the media stream expression is associated with a cell of the electronic spreadsheet. The media stream expression is for evaluation by the electronic spreadsheet to generate a resultant media stream from the media streams represented by the second arrangement of graphical objects. Accordingly, a system for generating a media stream expression for association with a cell of an electronic spreadsheet includes means for associating the media stream expression with a cell of the electronic spreadsheet. For example, as illustrated in FIG. 2, a cell list manager component 210 is configured for associating the media stream expression with a cell of the electronic spreadsheet.

Once a media stream expression has been generated using formula builder component 208 based on input received from the dialog input manager component 206, the transformation expression composite stream function can be assigned to a cell in a variety of ways. For example, the media stream expression can be automatically associated with a cell by the cell list manager component 210. For example, invoking the “Paste Visual Arrangement” command from a context menu can result in assigning the media stream expression in the cell. FIG. 4 illustrates an exemplary context menu 414 displayed in spreadsheet cell “D4”. The command can be invoked and the input event can be forwarded by the system pointing device manager component 302 to the UI input manager component 304. Alternatively or in addition, the keyboard manager component 306 can send spreadsheet command and actions to the UI input manager component 304 for processing.

When the command is invoked, the cell list manager component 210 can receive the address of the cell “D4” and the text contents of the current media stream expression previously formulated. The cell list manager component 210 can associate the media stream expression with the cell by calling the spreadsheet manager component 308 to store the value of transformation expression the composite stream formula in the storage area in memory for spreadsheet cell “D4”. The spreadsheet manager component 308 can call the spreadsheet renderer component 310 to update the spreadsheet display. The next time the spreadsheet is played, the cell renders with the composite stream, as formed using the dialog renderer component 204. For example, the composite media stream constructed in FIG. 5B can be presented in the spreadsheet in cell “E8” 416 of FIG. 4. According to an aspect, the resultant media stream can be presented in response to an evaluation of the media stream expression within the electronic spreadsheet. The spreadsheet renderer component 310 can be configured for presenting the resultant media stream in response to an evaluation of the media stream expression within the electronic spreadsheet.

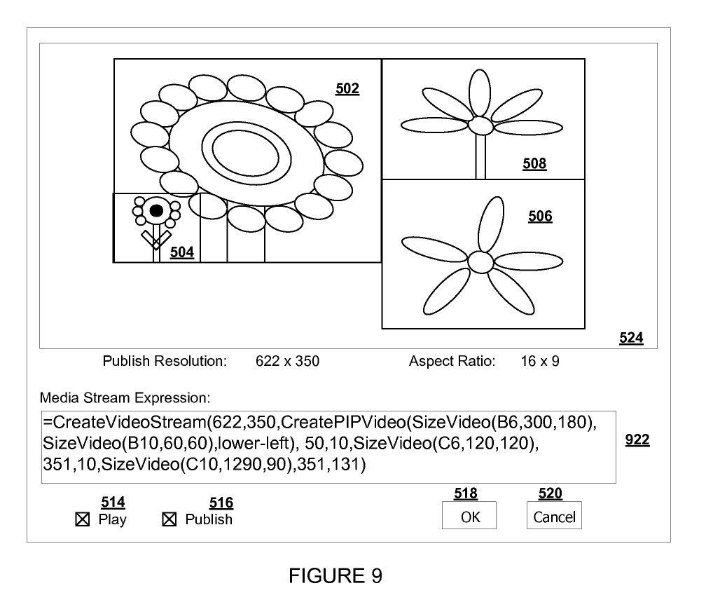

According to an aspect, the media stream expression can be presented in the graphical user interface in response to receiving input for manipulating the graphical objects. For example, the dialog renderer component 204 can be configured for presenting the media stream expression in the graphical user interface in response to receiving input for manipulating the graphical objects. In an example, FIG. 9 illustrates is a visual arrangement dialog where several video streams are arranged. FIG. 9 illustrates all the same information that FIG. 5B illustrates, and in addition illustrates a text string component 922 that represents a media expression function that corresponds to the current placement and size of the streams in the visual arrangement dialog component 524. As the streams are dragged and sized visually, the media stream expression illustrated in component 922 can be updated dynamically by the dialog renderer component 204. The text string component 922 can be a text entry control where the contents in the control can be modified using text entry within the control. The media expression in the control can be altered by changing the text content through text entry within the control. In this case, the dialog input manager component 206 process the keyboard input to the text formula analyzing each parameter of the function. Based on the values of each parameter the size and location of each stream is updated in the visual arrangement dialog display area component 524. With this function, the user can manipulate the visual arrangement graphically with drag-and-drop and sizing functions, directly by altering the transformation formula, or any combination of both techniques to achieve the desired result. The above examples illustrate simple move, sizing, volume, and muting operations. Any operation that can be performed on a media stream can be applied in the dialog described above. For example, adjusting the brightness of a video, or introducing additional echo in an audio stream can be accomplished using the system described above. Further, a two dimensional dialog is described above, but a three dimensional (3D) dialog can also be used. The 3D layout can include a model of the room or area where the final streams are to be played.

It should be understood that the various components illustrated in the various block diagrams represent logical components that are configured to perform the functionality described herein and can be implemented in software, hardware, or a combination of the two. Moreover, some or all of these logical components can be combined, some can be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any medium that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g), or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention can be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for generating a media stream expression for association with a cell of an electronic spreadsheet, the method comprising:
receiving a selection including at least one cell included in an electronic spreadsheet having a plurality of cells, wherein the selection includes a plurality of media streams associated with the at least one cell;
presenting a graphical user interface including graphical objects presented in a first arrangement representing the plurality of media streams;
receiving input via the graphical user interface for manipulating at least one of the graphical objects for presenting the graphical objects in a second arrangement;
generating a media stream expression based on the second arrangement of graphical objects; and
associating the media stream expression with a cell of the electronic spreadsheet, the media stream expression for evaluation by the electronic spreadsheet to generate a resultant media stream from the media streams represented by the second arrangement of graphical objects.

2. The method of claim 1 wherein receiving input for manipulating at least one of the graphical objects includes receiving input for sizing a graphical object and wherein the media stream expression, when evaluated by the electronic spreadsheet, generates a resultant media stream including the stream represented by the graphical object presented according to presentation parameters defined by the sizing of the graphical object.

3. The method of claim 1 wherein receiving input for manipulating at least one of the graphical objects includes receiving input for arranging the graphical objects in a sequence and wherein the media stream expression, when evaluated by the electronic spreadsheet, generates a resultant media stream including the streams represented by the graphical objects presented in the sequence.

4. The method of claim 1 wherein receiving input for manipulating at least one of the graphical objects includes receiving input for overlaying a first graphical object over a second graphical object and wherein the media stream expression, when evaluated by the electronic spreadsheet, generates a resultant media stream including the stream represented by the first graphical object presented overlaying the stream represented by the second graphical object.

5. The method of claim 1 wherein receiving input for manipulating at least one of the graphical objects includes receiving input for moving a graphical object along a path in the graphical user interface and wherein the media stream expression, when evaluated by the electronic spreadsheet, generates a resultant media stream including the stream represented by the graphical object presented along the path.

6. The method of claim 1 wherein receiving input for manipulating at least one of the graphical objects includes receiving input for positioning a graphical object in a location associated with a representation of a media output device included in the graphical user interface and wherein the media stream expression, when evaluated by the electronic spreadsheet, generates a resultant media stream including the media stream represented by the graphical object configured for presentation by the media output device associated with the media output device representation.

7. The method of claim 1 including presenting the resultant media stream in response to an evaluation of the media stream expression within the electronic spreadsheet.

8. The method of claim 1 including presenting the media stream expression in the graphical user interface in response to receiving input for manipulating the graphical objects.

9. The method of claim 1 including presenting media stream information in the graphical user interface in response to receiving input for manipulating the graphical objects, wherein the media stream information represents presentation properties of the media streams represented by the graphical objects.

10. A system for generating a media stream expression for association with a cell of an electronic spreadsheet, the system comprising:
means for receiving a selection including at least one cell included in an electronic spreadsheet having a plurality of cells, wherein the selection includes a plurality of media streams associated with the at least one cell;
means for presenting a graphical user interface including graphical objects presented in a first arrangement representing the plurality of media streams;
means for receiving input via the graphical user interface for manipulating at least one of the graphical objects for presenting the graphical objects in a second arrangement;
means for generating a media stream expression based on the second arrangement of graphical objects; and
means for associating the media stream expression with a cell of the electronic spreadsheet, the media stream expression for evaluation by the electronic spreadsheet to generate a resultant media stream from the media streams represented by the second arrangement of graphical objects.

11. A system for generating a media stream expression for association with a cell of an electronic spreadsheet, the system comprising:
a cell selection manager component configured for receiving a selection including at least one cell included in an electronic spreadsheet having a plurality of cells, wherein the selection includes a plurality of media streams associated with the at least one cell;
a dialog renderer component configured for presenting a graphical user interface including graphical objects presented in a first arrangement representing the plurality of media streams;
a dialog input manager component configured for receiving input via the graphical user interface for manipulating at least one of the graphical objects for presenting the graphical objects in a second arrangement;
a formula builder component configured for generating a media stream expression based on the second arrangement of graphical objects; and
a cell list manager component configured for associating the media stream expression with a cell of the electronic spreadsheet, the media stream expression for evaluation by the electronic spreadsheet to generate a resultant media stream from the media streams represented by the second arrangement of graphical objects.

12. The system of claim 11 wherein the dialog input manager component is configured for receiving input for sizing a graphical object and wherein the formula builder component is configured for generating the media stream expression for, when evaluated by the electronic spreadsheet, generating a resultant media stream including the stream represented by the graphical object presented according to presentation parameters defined by the sizing of the graphical object.

13. The system of claim 11 wherein the dialog input manager component is configured for receiving input for arranging the graphical objects in a sequence and wherein the formula builder component is configured for generating the media stream expression for, when evaluated by the electronic spreadsheet, generating a resultant media stream including the streams represented by the graphical objects presented in the sequence.

14. The system of claim 11 wherein the dialog input manager component is configured for receiving input for overlaying a first graphical object over a second graphical object and wherein the formula builder component is configured for generating the media stream expression for, when evaluated by the electronic spreadsheet, generating a resultant media stream including the stream represented by the first graphical object presented overlaying the stream represented by the second graphical object.

15. The system of claim 11 wherein the dialog input manager component is configured for receiving input for moving a graphical object along a path in the graphical user interface and wherein the formula builder component is configured for generating the media stream expression for, when evaluated by the electronic spreadsheet, generating a resultant media stream including the stream represented by the graphical object presented along the path.

16. The system of claim 11 wherein the dialog input manager component is configured for receiving input for positioning a graphical object in a location associated with a representation of a media output device included in the graphical user interface and wherein the formula builder component is configured for generating the media stream expression, when evaluated by the electronic spreadsheet, generating a resultant media stream including the media stream represented by the graphical object configured for presentation by the media output device associated with the media output device representation.

17. The system of claim 11 including a spreadsheet renderer component configured for presenting the resultant media stream in response to an evaluation of the media stream expression within the electronic spreadsheet.

18. The system of claim 11 wherein the dialog renderer component is configured for presenting the media stream expression in the graphical user interface in response to receiving input for manipulating the graphical objects.

19. The system of claim 11 wherein the dialog renderer component is configured for presenting media stream information in the graphical user interface in response to receiving input for manipulating the graphical objects, wherein the media stream information represents presentation properties of the media streams represented by the graphical objects.

20. A computer readable medium including a computer program, executable by a machine, for generating a media stream expression for association with a cell of an electronic spreadsheet, the computer program comprising executable instructions for:
receiving a selection including at least one cell included in an electronic spreadsheet having a plurality of cells, wherein the selection includes a plurality of media streams associated with the at least one cell;
presenting a graphical user interface including graphical objects presented in a first arrangement representing the plurality of media streams;
receiving input via the graphical user interface for manipulating at least one of the graphical objects for presenting the graphical objects in a second arrangement;
generating a media stream expression based on the second arrangement of graphical objects; and
associating the media stream expression with a cell of the electronic spreadsheet, the media stream expression for evaluation by the electronic spreadsheet to generate a resultant media stream from the media streams represented by the second arrangement of graphical objects.
